(19) United States
(12) Patent Application Publication
(10) Pub. No.: US 2006/0278775 A1
(43) Pub. Date: Dec. 14, 2006

(54) Adjustable mount assembly

(76) Inventors: Clyde G. Allen, Lapeer, MI (US); Dean D. Dennis, Lapeer, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/415,951

(22) Filed: May 1, 2006

Related U.S. Application Data
(60) Provisional application No. 60/676,386, filed on Apr. 29, 2005.

(51) Int. Cl. F16M 11/00

(52) U.S. Cl. 248/176.1

(57) ABSTRACT

An adjustable mount assembly has a mounting bracket constructed and arranged to be attached to a sub-surface of a wall covered with siding material. A cover member of the assembly attaches telescopically to the mounting bracket via a shuttle. A multi-positioning coupling feature is preferably carried between the mounting bracket and the shuttle and a single positioning coupling feature is preferably carried between the shuttle and the cover member.

### RELATED APPLICATION

This non-provisional patent application claims priority to and all advantages of U.S. Provisional Patent Application No. 60/676,386 that was filed on Apr. 29, 2005.

### FIELD OF THE INVENTION

The present invention relates generally to an adjustable mount assembly for mounting to a wall, and more particularly to a telescoping mount assembly having a front cover member that is removable and telescopically adjustable between various positions for accommodating various thicknesses of building material on the wall.

### BACKGROUND OF THE INVENTION

Especially common in residential building structures, exterior walls are know to be covered with a siding material typically made of aluminum or plastic. Often, various exterior appendages of the home such as drying vents, exterior light fixtures and water spigots must be trimmed-out for aesthetic reasons. This is commonly done with two piece trim kits or mounting assemblies having a mounting bracket with a flange that is nail to the wall beneath the siding and a cover member that snap fits to the mounting bracket.

During construction of the building, once the mounting bracket is secured to the wall, the siding material is installed over the wall and typically abutted against the mounting bracket. After installation of siding, the cover member is snap fitted in an axial direction to the mounting bracket. A trim piece of the cover member projects radially outward to cover the abutment of the siding edges to the mounting bracket.

Although the trim piece is orientated over or external from the siding, ideally it is as flush with the siding for a pleasing appearance. Unfortunately, different sidings have different thicknesses hence achieving a flush appearance requires a different mounting assembly for each thickness of siding. Because the mounting assemblies are typically made of injection molded plastic, multiple injection molds would be required to produce an array of mounting assemblies (i.e. one for each siding thickness). Unfortunately, manufacturing of such an array is expensive and further complicates stocking of the product.

### SUMMARY OF THE INVENTION AND AD ADVANTAGES

An adjustable mount assembly has a mounting bracket constructed and arranged to be attached to a sub-surface of a wall covered with siding material. A cover member of the assembly attaches telescopically to the mounting bracket via a shuttle. A multi-positioning coupling feature is preferably carried between the mounting bracket and the shuttle and a single positioning coupling feature is preferably carried between the shuttle and the cover member.

Features and advantages of the present invention include an adjustable mounting assembly capable of being used over a wide range of siding thicknesses. Further advantages include a robust design, reduction in overall manufacturing costs, improved and more efficient service for the client, and simplification in stocking of trim kits and the like.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a perspective view of an adjustable mounting assembly embodying the present invention mounted to a sub-surface of a wall covered with siding;

FIG. 2 is an exploded perspective view of the adjustable mounting assembly;

FIG. 3 is a perspective view of a second embodiment of the adjustable mounting assembly; and

FIG. 4 is a perspective view of the second embodiment of the adjustable mounting assembly mounted to a sub-surface of a wall.

### DETAILED DESCRIPTION OF THE PREFERRED EMBODIMENTS

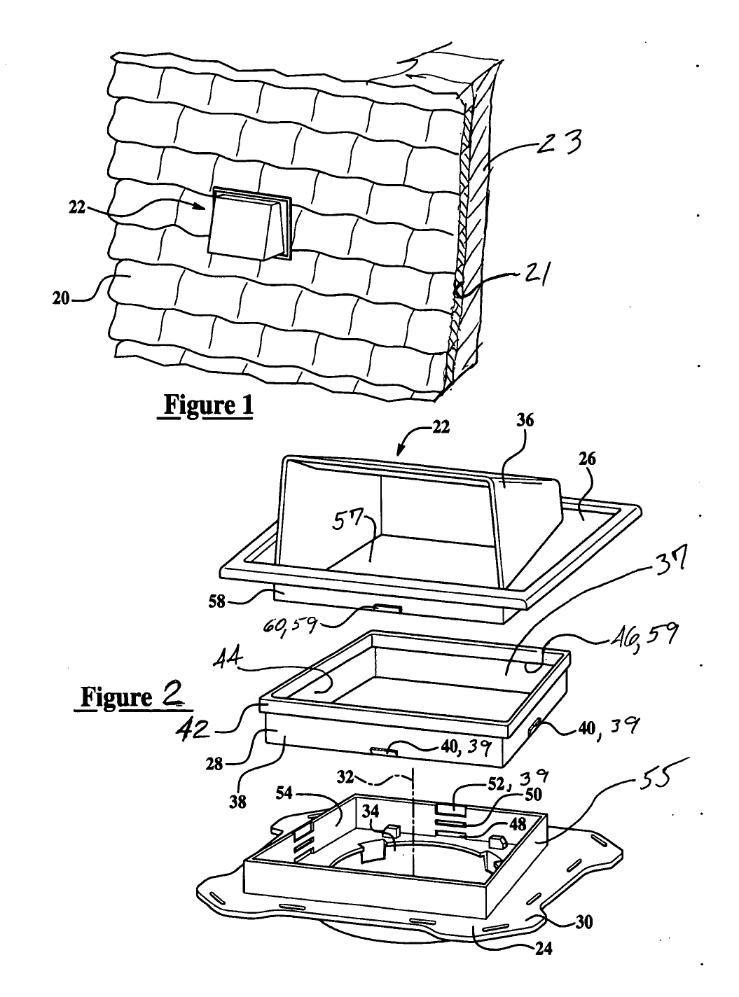

With reference to FIG. 1, an adjustable mount assembly 22 of the present invention is mounted to an exterior sub-surface 21 of a wall 23. The assembly 22 is helpful for accommodating various thicknesses of building material or siding 20 disposed on the wall 23. The assembly 22 is used for electrical outlets, light fixtures, etc., and the like.

Referring to FIG. 2, the assembly 22 includes a mounting bracket 24 that is integrally formed, a front cover member 26, and a shuttle or connector 28 for connecting the cover member 26 and the mounting bracket 24. The mounting bracket 24 has a nailing flange 30 disposed perpendicular and extending circumferentially about an axis 32. The flange 30 defines in-part an aperture 34. The mounting bracket 24 is secured to the wall 23 by any means including but not limited to the use of fasteners and adhesives. The aperture 34 allows members running within the wall 23 to extend through the wall 23. Such members may include but are not limited to piping, electrical cable, and duct work.

The front cover member 26 is disposed in parallel relation to the mounting bracket 24, the front cover member 26 covers the aperture 32. The front cover member 26 shown comprises a vent hood 36, by example and not meant to be limiting, for a dryer exhaust but for those skilled in the art it is known that the front cover member 26 does not require a vent hood 36. For example, the front cover member 26 could be planar, or the like.

The shuttle 28 connects the mounting bracket 24 and the front cover member 26 in the parallel relationship at various distances longitudinally along the axis 32. The shuttle 28 allows the distance to be adjustable. The shuttle 28 allows for convenient removal and/or replacement of the front cover member 26. In order to allow such a change, the shuttle 28 including a plurality of sidewalls 38, which defines an axially extending cavity 37, possesses a smaller, external perimeter measurement than the internal surface 54 measurement of the mounting bracket 24 such that the shuttle 28 snap-fit engages the mounting bracket 24 via a multi-positioning coupling feature 39. The shuttle 28 also includes a plurality of circumferentially spaced grooves or ribs 40, one rib 40 is centrally located on each sidewall 38 near the bottom of the sidewall 38. The ribs 40 of the coupling feature 39 are designed to align with corresponding grooves 48, 50 and 52 of the coupling feature 39 located on an inner surface 54 of sidewalls or circumferentially continuous collar 55 of the mounting bracket 24, even though only one of the grooves 48, 50 and 52 on the inner surface 54 of each sidewall of the mounting bracket 24 shall be used at any particular time. The grooves 40 engage and lock the shuttle 28 to the mounting bracket 24. The shuttle 28 further includes a circumferentially continuous peripheral lip 42 that extends beyond the sidewalls 38. On the inner surface 44 of the shuttle 28 is a stop 46 for limiting the distance that the front cover member 26 can travel when it snap-fit engages the shuttle 28.

The inner surface 54 of the mounting bracket 24 has grooves 48, 50 and 52, located in vertical, parallel alignment on the center of each sidewall 54 of the inner surface 56 of the mounting bracket 24. The grooves 48, 50 and 52 cooperate with the grooves 40 on the shuttle 28 to allow the assembly 20 to be laterally adjustable in relation to the axis 32.

The front cover member 26 includes a plurality of sidewalls or circumferentially continuous sleeve 58 that possess a smaller external perimeter measurement than the inner surface 44 measurement of the shuttle 28. The continuous sleeve 58 generally defines an axially extending hole 57 in the member 26 that communicates with the cavity 37. This construction permits snap-fit engagement of the front cover member 26 and the shuttle 28 via a single-positioning coupling feature 59. The front cover member 26 supports a centrally located and radially projecting tab or groove 60 of the coupling feature 59 at the bottom of each sidewall 58. The tab 60 cooperates with the stop 46 of the feature 59 carried by the shuttle 28. When the front cover member 26 is inserted into the shuttle 28, the tabs 60 carried by the front cover member 26 are limited from further movement once the tabs 60 engage the stop 46 of the shuttle. This construction signals to the user of the assembly 20 that the front cover member 26 is snap-fit engaged with the shuttle 28.

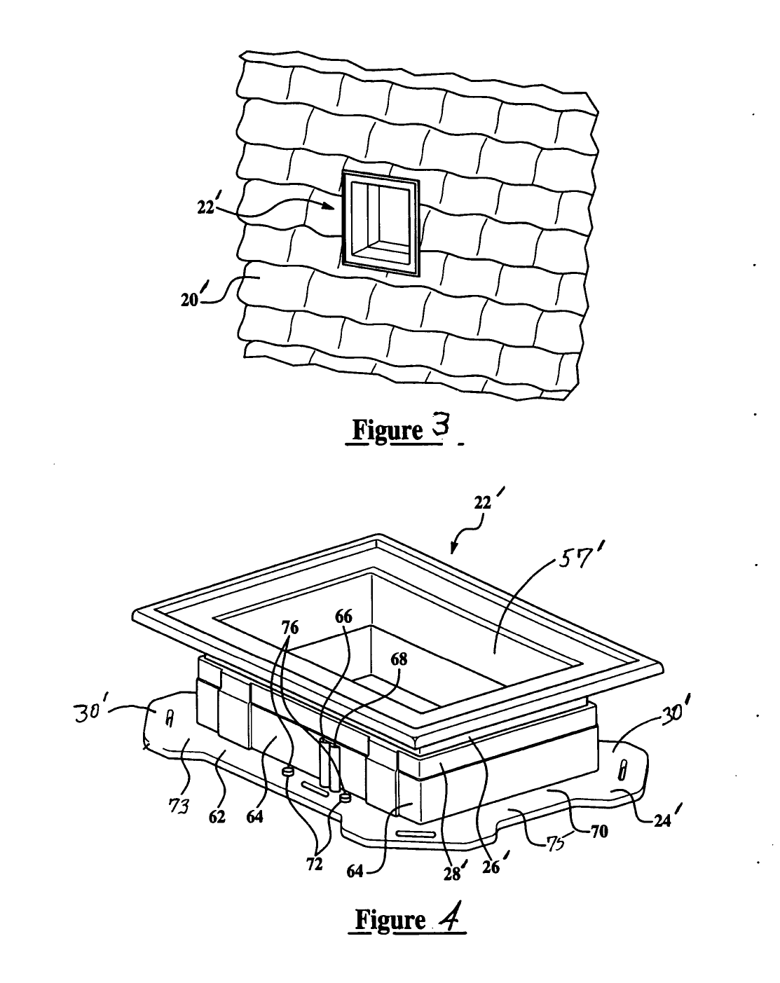

Referring to FIGS. 3 and 4, another embodiment of the assembly 22′ is shown. In this embodiment of the assembly 22′, the mounting bracket 24′ is not integrally formed as shown in the previous embodiment of the assembly 22′. The mounting bracket 24′ is used in the same manner as the previous discussed mounting bracket 24 but the construction is different. Particularly, the mounting bracket 24′ includes a first portion 62 and a second portion 70. The first portion 62 has a plurality of interconnecting sidewalls 64, or interconnecting collar segments, that resemble the shape of a letter “U” when the first portion 62 and the second portion 70 are not connected. Slots 66 are formed on the sidewalls 64 that define open end connection locations of the U-shaped first portion 62. The slots 66 are constructed to receive protruding projections 68 formed on the sidewalls 64 that define open end connection locations of the U-shaped second portion 70. The first portion 62 also includes four parallel aligned apertures 72 in a first segment 73 of the flange 30′, more particularly, two apertures 72 are parallel aligned and located on each side of the first segment 73 adjacent the slots 66 formed on the sidewalls 64. The apertures 72 are formed to mate with two parallel aligned pins 76 located on each side of a second segment 75 of the flange 30′ adjacent the protruding projections 68 formed on the sidewalls 64 of the second portion 70.

Assembly of the mounting bracket 24′ requires that the protruding projections 68 of the second portion 70 be inserted in the slots 66 of the first portion 62. Furthermore, assembly of the mounting bracket 24′ requires that the pins 76 of the second portion 70 be inserted in the apertures 72 of the first portion 62. This construction interlocks the first portion 62 and the second portion 76 to form the mounting bracket 24′. As previously asserted, the mounting bracket 24′ includes grooves 48′, 50′ and 52′ on the inner surface 54′ that are in vertical, parallel alignment. The grooves 48′, 50′ and 52′ cooperate with the rib 40′ on the shuttle 28′ to allow the assembly 22′ to be laterally adjustable in relation to the axis 32′. The shuttle 28′ in this embodiment is constructed and operates in the same manner as the shuttle 28 in the previous embodiment.

The front cover member 26′ used in this embodiment of the assembly 22 connects to the shuttle 28′ in the same manner as previously asserted. The front cover member 26′ shown in this embodiment lacks the vent hood 36 shown in the previous embodiment of the assembly 22. The omission of the vent hood 36 was shown for example only and not meant to be limiting.

The invention has been described in an illustrative manner, and it is to be understood that the terminology which has been used is intended to be in the nature of words of description rather than of limitation. Obviously, many modifications and variations of the present invention are possible in light of the above teachings. It is, therefore, to be understood that reference numerals are utilized merely for convenience and are not to be limiting in any way, and that the invention may be practiced otherwise than as specifically described.

What is claimed is:

1. An adjustable mount assembly for mounting to a sub-surface of a wall covered with a siding material and for trimming-out the siding material, the adjustable mount assembly comprising:
an axis disposed extending outward from the wall;
a mounting bracket engaged to the sub-surface;
a telescoping shuttle movable along the axis;
a cover member;
a multi-positioning coupling feature carried between the shuttle and one of the mounting bracket or the cover member; and
a single-positioning coupling feature carried between the shuttle and the other of the mounting bracket or the cover member.

2. The adjustable mount assembly set forth in claim 1 further comprising the mounting bracket having a planar flange and a collar projecting axially outward from the flange.

3. The adjustable mount assembly set forth in claim 2 wherein the multi-positioning coupling feature is carried between the shuttle and the mounting bracket.

4. The adjustable mount assembly set forth in claim 3 further comprising:
a first rib of the multi-positioning coupling feature projecting radially outward from the shuttle; and
a first set of at least two grooves of the multi-positioning coupling feature, wherein each one of the at least two grooves are spaced axially apart from one-another and opened radially inward for selective and snap fitting receipt of the first rib.

5. The adjustable mount assembly set forth in claim 4 further comprising:
a second rib of the multi-positioning coupling feature projecting radially outward from the shuttle and orientated diametrically opposite to the first rib; and
a second set of at least two grooves of the multi-positioning coupling feature, wherein each one of the at least two grooves are spaced axially apart from one-another and opened radially inward for selective and snap fitting receipt of the second rib.

6. The adjustable mount assembly set forth in claim 4 further comprising:
a cavity in the shuttle opened at least axially outward with respect to the wall;
a first stop of the single-positioning coupling feature carried by the shuttle and facing axially inward with respect to the wall;
a first tab of the single-positioning coupling feature projecting radially outward from the cover member for locking contact with the first stop.

7. The adjustable mount assembly set forth in claim 6 further comprising:
a second stop of the single-positioning coupling feature carried by the shuttle and facing axially inward with respect to the wall and disposed diametrically opposite the first stop; and
a second tab of the single-positioning coupling feature projecting radially outward from the cover member for locking contact with the second stop.

8. The adjustable mount assembly set forth in claim 7 further comprising a peripheral lip of the shuttle projecting radially into the cavity and carrying a continuous stop having the first and second stops.

9. The adjustable mount assembly set forth in claim 2 further comprising a peripheral trim piece of the cover member projecting radially outward and spaced adjustably axially away from the flange by the shuttle.

10. The adjustable mount assembly set forth in claim 1 wherein the cover member has a unitary vent hood.

11. The adjustable mount assembly set forth in claim 6 further comprising:
a peripheral trim piece of the cover member projecting radially outward and spaced adjustably axially away from the flange by the shuttle; and
a sleeve of the cover member projecting axially inward with respect to the wall from the peripheral trim piece, wherein the sleeve carries the tab.

12. The adjustable mount assembly set forth in claim 11 further comprising a hole extending through the cover member, defined by the sleeve, and communicating axially with the cavity.

13. The adjustable mount assembly set forth in claim 1 wherein the each one of the mounting bracket the shuttle and the cover member are a unitary piece of injection molded plastic.

14. The adjustable mount assembly set forth in claim 12 further comprising:
an aperture extending axially through the mounting bracket and communicating with the cavity; and
wherein the flange is generally bisected into first and second portions each having a segment of the flange and each having a segment of the collar.

15. The adjustable mount assembly set forth in claim 14 further comprising:
at least one aperture in the first flange segment; and
at least on pin of the second flange segment projecting axially through each respective one of the at least one aperture.

16. The adjustable mount assembly set forth in claim 14 further comprising an axially extending slot in the first collar segment opened circumferentially for receipt of the second collar segment.

17. An adjustable mount assembly for mounting to a sub-surface of a wall covered with a siding material, the adjustable mount assembly comprising:
an axis disposed extending outward from the wall;
a mounting bracket engaged having a radially outward projecting flange engaged to the sub-surface;
a cover member;
a telescoping shuttle movable along the axis and engaged adjustably between the mounting bracket and the cover member; and
an aperture in the mounting bracket communicating axially with a cavity in the shuttle communicating axially with a hole in the cover member.

18. An adjustable mount assembly set forth in claim 17 further comprising:
a multi-positioning coupling feature carried between the shuttle and the mounting bracket; and
a single-positioning coupling feature carried between the shuttle and the cover member.
